(19) United States
(12) Patent Application Publication
(10) Pub. No.: US 2002/0118636 A1
(43) Pub. Date: Aug. 29, 2002

(54) Mesh network protection using dynamic ring

(76) Inventors: Peter W. Phelps, Nepean (CA); Evert E. Deboer, Nepean (CA); Dave Langridge, Essex (GB); Joseph Olajubu, Essex (GB)

Correspondence Address: DOWELL & DOWELL, P.C., Suite 309, 1215 Jefferson Davis Highway, Arlington, VA, 22202, US

(21) Appl. No.: 09/739,675

(22) Filed: Dec. 20, 2000

(51) Int. Cl. H04L 1/00

(52) U.S. Cl. 370/222; 370/248

(57) ABSTRACT

A method and apparatus for redirecting data communications traffic in a mesh network via an alternate path. When operating in a SONET environment, the method makes use of bi-directional line switching ring (BLSR) principles in addition to a dynamically invoked flexible ring formation mechanism. The network comprises a plurality of computing nodes, where the plurality of computing node are interconnected to one another by a plurality of communication links and exchange traffic with one another over the communication links. The method includes detecting a failure on a certain communication link, the certain communication link interconnecting a first computing node and a second computing node. Upon detecting a failure on the certain communication link, at least one ring protection path is generated between the first computing node and the second computing node, where the ring protection path excludes the certain communication link. A least part of the traffic from the certain communication link is redirected through the ring protection path. The method makes use of the spare transport capacity on the communication links to carry the redirected traffic between the first computing node and the second computing node.

### FIELD OF THE INVENTION

This invention relates to the field of computer networks and more particularly to a method and apparatus for providing traffic redirection in the event of a communication link failure in a mesh network.

### BACKGROUND OF THE INVENTION

Communications networks typically comprise a plurality of computing nodes interconnected to one another by a plurality of communication links. The computing nodes in a given network exchange data and control traffic with one another over the communication links. A common network configuration is a mesh configuration where a given computing node may (or may not) be connected to any other node in the network. In the case of a communication link failure, the traffic transported over the failed communication link must be redirected to another communication link otherwise the data carried over the failed communication link will be lost.

Providing traffic redirection in a mesh network is often complex due to the number of possible failure scenarios. Frequently, many of the network's computing nodes are connected to 3 or more other computing nodes in the mesh network causing the complexity of providing network protection capability to increase exponentially with the number of connections. A method for providing traffic redirection includes automatically switched optical networks, also known under the acronym ASON. A deficiency with the above-described method is that it is complex and costly to implement and may require overlaying an additional communications network for providing control signaling and also may introduce significant delays in establishing protection switching.

Consequently, there is a need in the industry for providing a method and apparatus for traffic redirection in the event of a communication link failure in a mesh network that at least in part alleviates the problems associated with the prior art.

### SUMMARY OF THE INVENTION

In accordance with a broad aspect, the invention provides a method for redirecting traffic in a mesh network comprising a plurality of computing nodes, where the plurality of computing node are interconnected to one another by a plurality of communication links. The computing nodes are operative for exchanging traffic with one another over the communication links. The method comprises detecting a failure on a certain communication link part of the plurality of communication links, the certain communication link interconnecting a first computing node and a second computing node. Upon detecting a failure on the certain communication link, a ring protection path is generated between the first computing node and the second computing node, where the ring protection path excludes the certain communication link. At least part of the traffic from the certain communication link is then redirected to the ring protection path around the failed link. The ring protection path is a new route through which traffic can be directed.

The ring protection path is formed dynamically when a failure in a communication link is detected. Advantageously, this allows flexibility in utilizing spare transport capacity in communication links. Spare transport capacity is allocated, as it is required, to protect specific failures at the time of the failure. In other word, the spare transport capacity does not need to be dedicated to a specific failure condition. In a specific implementation, where the traffic is in the SONET/SDH format, the dynamic ring protection mechanism makes use of the existing BLSRring network communication protocol to establish and re-connect the traffic from a failed communication link over the newly established ring protection path around the failed communication link. In a non-limiting example, the ring protection path is a bi-directional line-switching ring (BLSR). Advantageously, making use of the known (BLSR) protocol and generating the computing nodes that are members of the rings as required offers a flexible method of defining ring protection paths.

The ring protection path includes a group of communication links, the communication links having respective spare transport capacities prior to the redirecting of at least part of the failed traffic capacity.

Typically, the ring protection path from the first computing node to the second computing node includes a third (or more) computing node distinct from the second computing node. In a specific implementation, where the first computing node is connected to the third computing node through a second communication link, the generation of the ring protection path comprises transmitting a message from the first computing node to the third computing node in the network through the second communication link. The message is indicative of a request for generating a ring protection path between the first computing node and the second computing node.

In a non-limiting example, the messages indicative of a request for generating a ring protection path are transmitted over the communication links in the network. In a specific example where the communication between the computing nodes is effected using the SONET/SDH protocol, the messages are sent within the SONET frames. Advantageously, this allows the generation of the ring protection path without requiring a separate overlaid control network over the existing data network for transmitting signaling messages.

In a non-limiting example of implementation, the ring protection path is a first ring protection path, the method further includes generating a set of N ring protection paths between the first computing node and the second computing node. Each ring protection path in the set of N ring protection paths excludes the certain communication link. At least part of the traffic from the certain communication link is redirection through the ring protection paths in the set of N ring protection paths.

Each ring protection paths in the set of N ring protection paths includes a group of communication links, the communication links having respective spare transport capacities prior to the redirecting of a least part of the traffic from the certain communication link through the ring protection paths. The spare transport capacities available in each respective communication link are used to carry a respective portion of the redirected traffic from the first computing node to the second computing node. Another advantage of using N ring protection paths, where N is 2 or more, is that only a part of the traffic on a failed communication link needs to be carried by a single given ring protection path.

Advantageously, the above-described method does not require dedicated protection links.

In accordance with another broad aspect, the invention further provides a network implementing the above-described method.

In accordance with another broad aspect, the invention provides a computer readable medium comprising a program element suitable for execution by a computing apparatus for implementing the above-described method.

In accordance with another broad aspect, the invention provides a computing node suitable for use in a network having a plurality of computing nodes. The computing node comprises a port through which traffic can be exchanged between the computing node and a remote computing node over a certain communication link. The computing apparatus also includes a processing unit being responsive to the occurrence of a failure on the certain communication link for causing the generation of a certain ring protection path between the computing node and the remote computing node. The ring protection path is generated on the basis of a set of alternate paths between the computing node and the remote computing node, the set of alternate paths including at least one path excluding the certain communication link. The processing unit then redirects at least part of the traffic from the certain communication link to the ring protection path.

In a non-limiting implementation, the computing node further comprises a memory unit for storing a set of network paths from the computing node to a second computing node in the network.

In accordance with another broad aspect, the invention provides a network having a mesh configuration comprising a plurality of computing nodes of the type described above, the plurality of computing node being interconnected to one another by a plurality of communication links.

For the purpose of this specification, the expression “mesh-type network” designates a network having a plurality of computing nodes, where a computing node may (or may not) be connected to any other node in the network.

For the purpose of this specification, the expression “computing node” is used broadly to designate a “network element”, an “add-drop multiplex node” or a generic “node” in a communications network.

The expression traffic is used broadly to include data traffic, control traffic and traffic having both data and control information. In a specific non-limiting example, the traffic is in the SONET/SDH format.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 is a schematic diagram of a specific example of mesh-type network;

FIG. 2 is a block diagram of a computing node in accordance with a specific example of implementation of the present invention;

FIG. 3 is a schematic diagram of the mesh-type network of FIG. 1 including a failure on a communication link;

FIG. 4 is a flow diagram depicted the traffic redirection process in accordance with a specific example of implementation of the invention;

FIG. 5 is a block diagram of an apparatus for implementing the traffic redirection process in accordance with a specific example of implementation of the invention.

### DETAILED DESCRIPTION

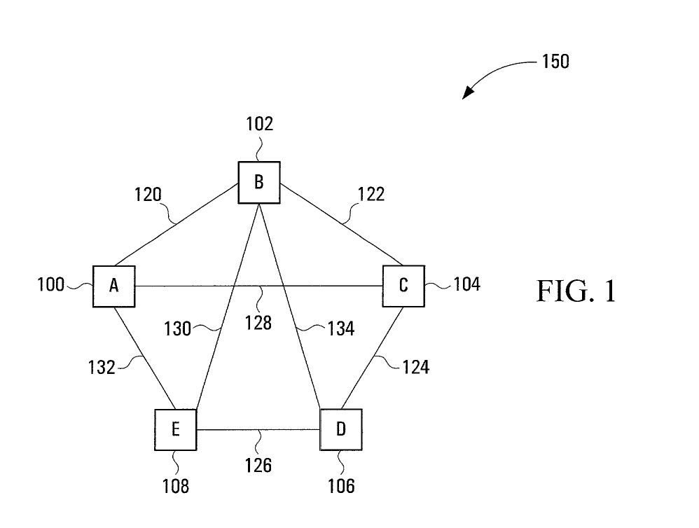

FIG. 1 of the drawings depicts a schematic diagram of a specific example of a mesh-type network 150 comprising a plurality of computing nodes 100, 102, 104, 106, 108 inter-connected to one another by a plurality of communication links 120, 122, 124, 126, 128, 130, 132, 134. The plurality of communication links 120 through 134 allows the computing nodes in the network 150 to exchange data between one another. The data exchanged between the computing nodes may be in any suitable format included, but not limited to SONET/SDH packets and ATM frames among others. For the purpose of the specific example of implementation presented below, the data exchanged between the computing nodes is in the SONET/SDH format allowing to make use of the existing BLSR protection mechanism in addition to a dynamically invoked flexible ring formation mechanism.

The communication links 120 through 134 may be optical links, coaxial cables, copper wires or any other type of communication link suitable for carrying traffic. Each communication links 120 through 134 has a certain data transport capacity. In the course of normal operation (where all the communication links are operational), each communication link may carry only a portion of its total transport capacity, and therefore, at least some of the communication links in the network 150 have spare data transport capacity. The spare transport capacity on the communication links is used to carry redirected traffic when a communication link fails.

In a non-limiting example, a given computing node in the network is interconnected with M other computing nodes in the network over M communication links. This invention is particularly advantageous when there is enough spare transport capacity in the M communication links to accommodate the traffic in case of a communication link failure of any one of the M communication links. In this fashion no traffic is lost. In yet a more specific example, the M communication links have substantially similar respective transport capacities. In the course of operation free of communication link failure, each communication link is provided with a spare transport capacity of at least 1/M percent of its maximum transport capacity. It will be readily observed that the higher the interconnectivity in the network (when M is large) the less spare transport capacity must be left on any one communication link. For example, computing node 100 is interconnected to three (3) other computing nodes over three communication links namely 120 128 132. In the course of normal operation, each communication link has a spare transport capacity of at least about ⅓≅33% of its total transport capacity and therefore carries at most about ⅔≅66% of its total transport capacity. When one of the communication links fails, the traffic carried on that communication link can be split between the two other remaining communication links. The skilled person in the art will readily appreciate that there are many other ways of providing spare transport capacity on communication links. The above was presented as only an example of implementation for providing enough spare transport capacity to accommodate the traffic of any one of the M communication links in the case of a communication link failure. Spare transport capacity is provided between computing nodes for protection to be possible. The distribution of spare transport capacity may vary and is generally based on the specific network requirements. It will be readily observed that some communication links may have more spare transport capacity than others and that the spare transport capacities may be non-symmetric.

The traffic redirection process provided in accordance with the spirit of the invention is advantageous in networks where there are at least two (M=2) communication links interconnecting a given computing node. The traffic redirection process provided in accordance with the spirit of the invention is also particularly advantageous in networks where there are at least three (M=3) communication links interconnecting a given computing node.

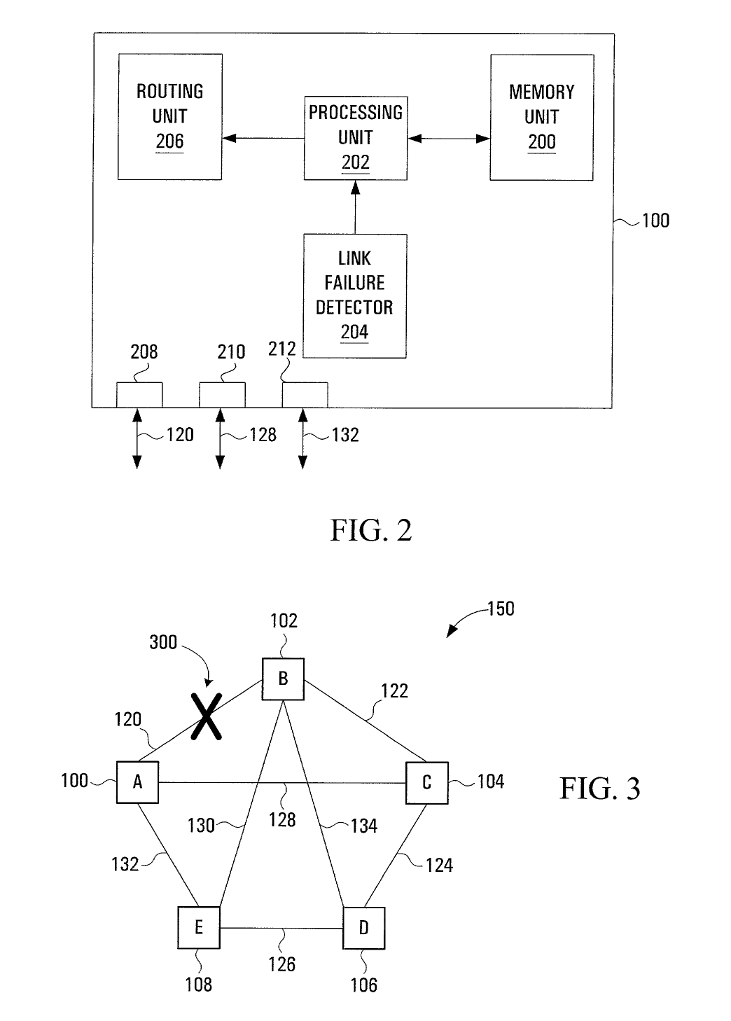

The structure and functioning of computing node 100 will now be described with reference to FIGS. 1 and 2 of the drawings. The structure and operation of computing nodes 102-108 are essentially identical to that of computing node 100 and for that reason will not be described. Computing node 100 is connected to computing nodes 102 104 and 108 through communication links 120 128 and 132 respectively.

FIG. 2 depicts a detailed block diagram of computing node 100. Computing node 100 includes a set of ports 208 210 212 through which traffic can be exchanged between the computing node 100 and remote computing nodes 102 104 108 through respective communication links 120 128 132. The computing node 100 also includes a processing unit 202, a memory unit or computer readable medium 200, a communication link failure detector 204 and a routing unit 206. The computing node 100 may also comprise other functional module for receiving, transmitting and processing data elements however a description of these functional modules is not necessary to the understanding of the present invention.

The routing unit 206 provides traffic routing capability to computing node 100. More specifically, the routing unit 206 has access to network topology information data elements associated to the network 150. The network topology information describes the interconnections of the various computing nodes in the network. The routing unit 206 makes use of the network topology information to determine through which communication link 120 128 132 a given traffic unit is to be transmitted from computing node 100. Routing is well known in the art to which this invention pertains and will not be described further here. In a specific, non-limiting example of implementation, the network topology information is stored in memory unit 200. The routing unit 206 at the computing node 100 is operatively coupled to the memory unit 200 through processing unit 202.

The link failure detector 204 is operative for monitoring communication links 120 128 132 to detect a failure in any one of these communication links. Failures may include for example a physical failure in the communication link, or associated communications equipment or any other state in the network that would cause a communication link to become non-operational. It will be readily appreciated that a failure condition in a communication link may also include degradation in the performance of the communication link. Link failure detection is well known in the art to which this invention pertains and will not be described further here. In a non-limiting example, when there is a failure in any one of communication links 120 128 132, the link failure detector 204 generates a signal in the form of an interrupt indicating that a certain communication link is in failure. This signal is communicated to the processing unit 202.

The memory unit 200 includes a database for storing sets of alternate paths in the network from the computing node 100 to remote computing nodes in the network when in the presence of a communication link failure. In a non-limiting example, the database is in the form of a table having an entry for each adjacent communication link connected to the computing node 100. Advantageously, limiting the number of entries in the memory unit to entries corresponding to communication links adjacent to computing node compared to providing entries for all communication links in the networks provides a reduction in computational and memory requirements at the computing node. It will be readily observe that the memory unit may include entries for communication links remote from the computing unit without detracting from the spirit of the invention. Each entry is associated to a set of alternate paths to be used in the event of a failure of the corresponding communication link. The alternate paths include a sequence of computing nodes establishing a path around the failed communication link. Table 1 below shows entries for communication links 120 and 132 in an example of such a data structure.

| Communication link | Alternate Paths | |
|---|---|---|
| Link 120 | 1. | node 100; node 104; node |
| | | 102; |
| | 2. | node 100; node 108; node |
| | | 102; |
| | 3. | node 100; node 108; node |
| | | 106; node 102; |
| Link 132 | 1. | Node 100; node 102; node |
| | | 108; |
| | 2. | Node 100; node 104; node |
| | | 106; node 108; |
| Link 128 | 1. | Node 100; node 102; node |
| | | 104; |
| | 2. | Node 100; node 108; node |
| | | 106; node 104; |

In the above table, if communication link 120 connecting computing nodes 100 and 102 fails, there are three alternate paths that are provided by memory unit 200. The alternate paths exclude communication link 120 since these paths are taken in the event of the failure of communication link 120. The skilled reader in the art will observe that in this specific example the alternate paths are expressed in terms of the computing nodes included in the alternate path. Alternatively, the alternate paths may be expressed in terms of the links taken in the path without detracting from the spirit of the invention. In the above table for communication link 120, it will be observed that the data structure does not necessarily include an exhaustive list of all possible alternate paths through the network between nodes 100 and 102 that exclude link 120 but may include a subset of those alternate paths. Other data structures for storing alternate paths such as trees, linked lists and others may be used without detracting from the spirit of the invention. The contents of the memory unit 200 may be manually entered into the memory unit by providing a computer readable medium providing network topology information. Alternatively, an automatic network discovery unit that provides the computing node 100 with knowledge of the network 150 connections may provide the contents of the memory unit 200. Automatic network topology discovery methods are well known in the art to which this invention pertains and hence will not be described in detail here. Optionally, each entry also includes a data element indicative of the amount of traffic that needs to be redirected in the event of failure of the communication link corresponding to the entry.

The processing unit 202 is operatively coupled to the memory unit 200, the link failure detector 204 and the routing unit 206. The processing unit 202 is responsive to the occurrence of a failure on one of the communication links 120 128 132 to cause the generation of a ring protection path to either one of computing nodes 102 104 and 108. The ring protection path, once established, carries redirected traffic from the failed communication link by using the spare transport capacity of the communication links part of the ring protection path. The ring protection path is communicated to the routing unit 206 such that any traffic originally directed to the failed communication link be routed through the ring protection path. In a specific implementation, the ring protection path is a bi-directional line-switching ring (BLSR) and the routing unit 206 is operative to switch traffic originally directed to the failed communication link through the ring protection path. For more information on bi-directional line switching rings (BLSR) the reader is invited to refer to the Bellcore generic requirements GR-1230-CORE, “SONET Bidirecional Line Switched Ring Equipment Generic Criteria” whose contents are hereby incorporated by reference. The processing unit 202 is also operative for receiving a message indicative of a request for establishing a ring protection path from another computing node in the network. Upon receipt of the request message, the processing unit 202 is operative to set up a ring protection path through routing unit 206 such that any traffic originally directed to the failed communication link be routed through the ring protection path. More specifically, upon receipt of a request to form a ring protection path, the processing unit 202 determines on the basis of the contents of the request message where to next send the request message i.e. the next node in the alternate path. The processing unit 202 then determines the spare transport capacity of the communication link to this next node. The processing unit is operative to transmit the request message to this next node together with a request for the capacity required or the capacity available on the communication link whichever is smaller.

The computing nodes adjacent to a failure perform the negotiation of telling the adjacent computing nodes their place in the ring protection path. Each computing node will therefore know which adjacent computing node to which to forward the messages in order to complete the ring protection path.

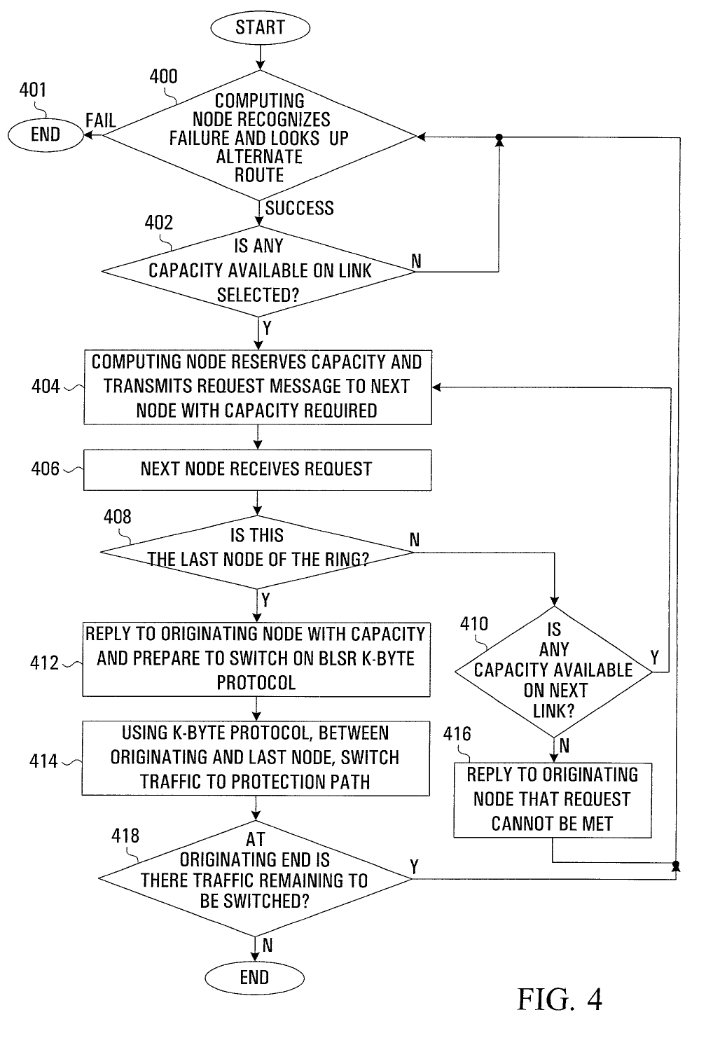

A typical interaction described in conjunction with FIGS. 3 and 4 will better illustrate the process of traffic redirection in the event of a communication link failure. As shown in FIG. 3, communication link 120 is in a state of failure where the failure is indicated by reference numeral 300.

In FIG. 4 at step 400, computing node 100 detects the failure 300 in communication link 120. More specifically, the link failure detector 204 in computing node 100 detects the failure in communication link 120 and issues a signal to the processing unit 202 in the form of an interrupt including information indicating that communication link 120 is in a state of failure. The processing unit accesses the entry corresponding to communication link 120 in memory unit 200 to locate an alternate path between computing node 100 and computing node 102, the alternate path excluding communication link 120. If no alternate path can be located, the process terminates at step 401. In this case, any non-redirected traffic will be lost.

For the purpose of this example, let us say that the first alternate path located in memory unit 200 is the path including computing nodes 100, 104 and 102. Computing node 100 first determines at step 402 whether there is any spare data transport capacity on the link between itself and the next computing node in the alternate path namely node 104. In the negative, the process returns to step 400 where the next alternate path between computing node 100 and computing node 102 is located. If computing node 100 determines that there is spare traffic transport capacity on the link between itself and the next computing node in the alternate path namely computing node 104, condition 402 is answered in the affirmative and the system proceeds to step 404. At step 404, the processing unit 202 temporarily reserves that excess transport capacity for use as the ring protection path and generates as request message to establish a ring protection path and transmits the request to the next computing node in the alternate path. More specifically, the processing unit 202 in computing node 100 generates a request message for transmission to computing nodes 104 and 102 in the alternate path. The request message indicates that the computing node 100 wants to establish a ring protection path including computing nodes 104 and 102. The request message is transmitted over the data communication links in the network. In a specific example where the communication between the computing nodes is effected using the SONET/SDH protocol, the messages may be sent within the SONET frames. In a non-limiting example, the messages may be sent using, among others, a “wrapper” communication channel, K-bytes (as is or by using multi-frame capability), a communications channel such as a line data communications channel (DCC/SDCC) provided by the SONET protocol. Alternatively, an external communications channel, such as an Ethernet link, is used to exchange messages establishing the ring protection path. At step 406, computing nodes 104 and 102 receive the request message and attempt to set up a ring protection path from computing node 100 to computing node 102.

More specifically, the request message is first sent to the next computing node in the path, which in the case is computing node 104. The request message includes the amount of spare transport capacity to be reserved on the ring protection path between computing node 100 and 102. At step 408, computing node 104 receives the request message and determines if it is the last node in the alternate path. In this example, condition 408 is answered in the negative and the process proceeds to step 410. At step 410, computing node 104 determines if there is any spare data transport capacity on the communication link 122 between computing node 104 and the next computing node in the alternate path namely computing node 102. If there is no spare transport capacity available in the following communication link 122, condition 410 is answered in the negative and at step 416, computing node 104 generates a reply message for transmission to the computing node having originated the request for a ring protection path (namely computing node 100) indicating that the request for establishing of a ring protection path cannot be granted. In a non-limiting example, any spare transport capacity temporarily reserved during the current attempt of establishing a ring protection path is released. The process then proceeded to step 400 where a next alternate path is located.

If there is spare data transport capacity on the communication link between computing node 104 and the next computing node in the alternate path, namely computing node 102, condition 410 is answered in the affirmative. In this case, the process returns to step 404 where computing node 104 temporarily reserves that excess transport capacity for use in the ring protection path. In a non-limiting example, the spare transport capacity requested of any communication link is no larger than the spare transport capacity reserved on the previous communication link in the path. The capacity reserved of following communication links is generally equal or smaller than the original request for a ring protection path from the originating computing node. If the request can be granted for a smaller transport capacity than that originally asked for, the request will be considered a success.

Computing node 104 then forwards the request message to the next computing node in the alternate path namely computing node 102 including the amount of spare transport capacity reserved on the communication link between computing node 104 and computing node 102. At step 406, computing node 102 receives the request message and, since it is the last computing node in the alternate path, condition 408 is answered in the affirmative and the process proceeds to step 412. Computing node 102 initiates the confirmation of the ring protection path indicating the reserved capacity. More specifically, at step 412 computing node 102 generates and transmits a reply message to the computing node having originated the request for the ring protection path, namely computing node 100. The reply message includes the capacity reserved on the ring protection path.

The established ring protection path is capable of carrying a quantity of redirected traffic dependent on the spare transport capacity associated with the given communication link having the lowest spare transport capacity in the ring protection path. For instance, the ring protection path going through computing nodes 104 and 102 from computing node 100 includes communication links 128 and 122. The communication link among those two links having the lowest spare transport capacity determines the maximum transport capacity of the ring protection path defined by computing nodes 100 104 and 102.

The originating computing node 100 upon receipt of the reply message may then decide whether the transport capacity reserved on the established ring protection path is useful. If it is useful, the process proceeds to steps 414. If the established ring protection path is determined not to be useful, computing node 100 may also consider the request to be unsuccessful and remove the ring protection path from that sequence of computing nodes. There are several reasons why a ring protection path may be considered not to be useful such as for example, the failed communication link is now operational, the capacity available on the ring protection path is not needed and others.

At step 414, computing node 100 receives the reply message. The computing nodes on the ring protection path switch (or redirect) the traffic from the failed communication link 120 to the established ring protection path on the basis of the reserved transport capacity available on the ring protection path. The ring protection path makes use of a ring network communication protocol to create, establish and release the ring protection path(s) between computing nodes in order to carry the redirected traffic from the first computing node to the last computing node over the ring protection path. In a very specific example, the computing nodes in the ring protection path make use of the K-byte protocol exchanged on the K-bytes within the SONET overhead to switch the traffic to the ring protection path. The process of setting up a ring protection path using SONET K-bytes with fixed computing nodes is described in Bellcore generic requirements GR-1230-CORE, “SONET Bidirecional Line Switched Ring Equipment Generic Criteria” whose contents are hereby incorporated by reference. Other methods may be used to switch the traffic to the ring protection path without detracting from the spirit of the invention.

At step 418, computing node 100 determines whether any further traffic remaining on failed link 120 needs to be redirected. If, after the redirection of at least part of the traffic to the ring protection path, there does not remain traffic to be redirected from the failed communication link 120, condition 418 is answered in the negative and the process is complete. If, after the redirection of at least part of the traffic to the ring protection path, there remains traffic to be redirected from the failed communication link 120, condition 418 is answered in the affirmative and the process goes back to step 400. At step 400 the next alternate path between computing node 100 and computing node 102 is located in the memory, the second alternate path excluding communication link 120. For example the alternate path including computing nodes 108 and 102 may be selected. The process is repeated until there is no traffic left to be redirected from the failed communication link 120 to ring protection paths or until there remains no alternate paths in the memory unit of computing node 100.

In this fashion, a set of N ring protection paths between the computing node 100 and the computing node 102, with each ring protection path in the set of N ring protection paths excluding communication link 120, can be established. On each ring protection path, a portion of the total traffic originally carried by communication link 120 is redirected, the paths each carrying a quantity of redirected (or switched) traffic in accordance with their respective and indicated transport capacities available.

Although in the process depicted in FIG. 4 ring protection paths are established sequentially and that the establishment of a second ring protection begins after the first ring protection path is established, it will be readily appreciated that several ring protection paths can be established substantially simultaneously. In a non-limiting example, if it is recognized at step 402 that insufficient capacity is available on a first ring protection path being currently established, then the establishment of a second ring protection path may be initiated at that time without waiting for the complete first ring protection path to be established. In that fashion, the first ring protection path and the second ring protection path are established substantially simultaneously.

When it is no longer required, such as in the case where the failed communication link re-acquires its operational status, the one or more ring protection paths can be removed in a similar way to how they was established. A detailed description of the removal of the ring protection paths will not be described in detail here. In a non-limiting example, the BLSR protocol is used to remove the protection switch of the traffic through the ring protection path. Following this, the communication channels are used to carry signalling information to release the reserved transport capacity and the computing nodes from the ring protection path.

In the above-described traffic redirection process, computing node 100 detects the failure of communication link 120. It will readily be apparent that computing node 102 may detect the failure of communication link 120 instead of or in addition to computing node 100. If computing node 102 detects the failure, than computing node 102 will issue a request message in order to cause one or more ring protection paths to be established. If both computing nodes 100 and 102 detect the failure of communication link 120, then they will both issue request messages to establish one or more ring protection paths. The intermediate computing nodes receiving the request messages are responsive to the fact that they have received two identical requests but from two adjacent nodes to the same failure. They will treat the requests as a single request and respond accordingly. In this way, the establishment of two separate ring paths to go around the same failure can be avoided.

The above-described functionality can be implemented on any suitable hardware platform. In a non-limiting example, the processing unit 202 is implemented on a dedicated hardware platform suitable for communicating with a memory unit such as an EPROM, RAM or other memory device suitable for implementing memory unit 200.

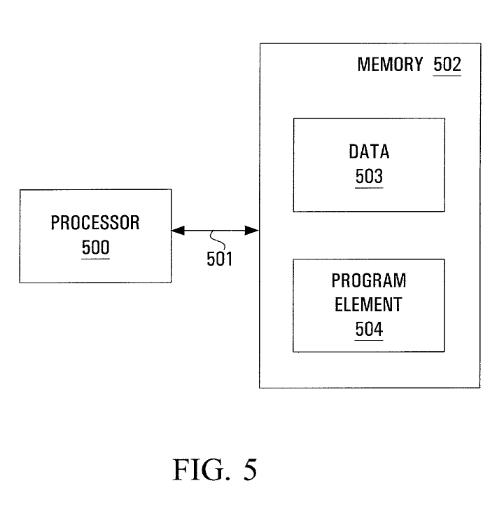

The above-described method and system described in the specification can also be implemented on any suitable computing platform as shown in FIG. 5. Such a computing platform typically includes a processor 500 and a memory or computer readable medium 502 connected to the processor 500 by a data communication bus 501. The memory stores the data 503 and the instructions of the program element 504 implementing the functional blocks depicted in the drawings and described in the specification. In a specific example, the program element 504 when executing on the processor 500 implements the processing unit 202 and the data 503 stored the contents of memory unit 200.

Although the present invention has been described in considerable detail with reference to certain preferred embodiments thereof, variations and refinements are possible without departing from the spirit of the invention. Therefore, the scope of the invention should be limited only by the appended claims and their equivalents.

1. A computing node suitable for use in a network having a plurality of computing nodes, said computing node comprising:
a) a port through which traffic can be exchanged between the computing node and a remote computing node over a certain communication link;
b) a processing unit being responsive to the occurrence of a failure on the certain communication link for:
(1) causing the generation of a certain ring protection path between the computing node and the remote computing node on the basis of a set of alternate paths between the computing node and the remote computing node, the set of alternate paths including at least one path excluding the certain communication link;
(2) redirecting a least part of the traffic from the certain communication link to the certain ring protection path.

2. A computing node as defined in claim 1, wherein the ring protection path is a bi-directional line switching ring (BLSR).

3. A computing node as defined in claim 1, said computing node further comprising a memory unit for storing a set of alternate paths from the computing node to the remote computing node in the network, the alternate paths excluding the certain communication link.

4. A computing node as defined in claim 1, wherein the remote computing node is a first remote computing node, the ring protection path including a second remote computing node distinct from the first remote computing node.

5. A computing node as defined in claim 1, wherein the ring protection path includes a group of communication links, the communication links having respective spare transport capacities prior to the redirecting of a least part of the traffic.

6. A computing node as defined in claim 5, wherein the ring protection path is capable of carrying a quantity of redirected traffic dependent on a spare transport capacity associated to a given communication link in the group of communication links.

7. A computing node as defined in claim 6, wherein the given communication link has the lowest spare transport capacity in the group of communication links.

8. A computing node as defined in claim 1, wherein said ring protection path is a first ring protection path, said processing unit being responsive to the occurrence of a failure on the certain communication link for:
i) causing the generation of a second ring protection path on the basis the set of alternate paths between the computing node and the remote computing node, the second ring protection path excluding the certain communication link;
ii) redirecting at least another part of the traffic from the certain communication link to the second ring protection path.

9. A computing node as defined in claim 8, wherein the second ring protection path includes a second group of communication links and wherein, subsequent to the redirecting of at least part of the traffic from the certain communication link to the first ring protection path, the communication links in the second group of communication links having respective spare transport capacities prior to the redirecting of at least another part of the traffic from the certain communication link to the second ring protection path.

10. A computing node as defined in claim 9, wherein the second ring protection path is capable of carrying a quantity of redirected traffic dependent on a spare transport capacity associated to a given communication link in the second group of communication links.

11. A computing node as defined in claim 10, wherein the given communication link in the second group of communication links has the lowest spare transport capacity in the second group of communication links.

12. A computing node as defined in claim 1, wherein said processing unit being responsive to the occurrence of a failure on the certain communication link for:
i) causing the generation a set of N ring protection paths on the basis the set of alternate paths between the computing node and the remote computing node, each ring protection path in the set of N ring protection paths excluding the certain communication link;
ii) redirecting at least part of the traffic from the certain communication link through the ring protection paths in the set of N ring protection paths.

13. A computing node as defined in claim 12, wherein each ring protection path in the set of N ring protection paths includes a group of communication links, the communication links having respective spare transport capacities prior to the redirecting of a least part of the traffic from the certain communication link through the ring protection paths in the set of N ring protection paths.

14. A computing node as defined in claim 1, wherein the remote computing node is a first remote computing node and wherein causing the generation of the ring protection path comprises transmitting a message to a second remote computing node, the message being indicative of a request for generating a ring protection path excluding the certain communication link between the computing node and the first remote computing node.

15. A mesh network comprising a plurality of computing nodes of the type defined in claim 1, the plurality of computing node being interconnected to one another by a plurality of communication links.

16. A network as defined in claim 15, wherein the plurality of communication links is suitable for exchanging traffic between computing nodes.

17. A network as defined in claim 16, wherein in operation at least some of the communication links have spare transport capacity.

18. A network as defined in claim 17, wherein in operation, all the communication links have spare transport capacity.

19. A network as defined in claim 17, wherein a given computing node in the network when causing the generation a ring protection path is operative to transmit a message over a communication link to another computing node in the network, the message being indicative of a request for generating a ring protection path.

20. A network as defined in claim 17, wherein a given computing node in the network is interconnected with M other computing nodes in the network over M communication links.

21. A network as defined in claim 20, wherein the M communication links have substantially similar respective transport capacities, in operation the communication links having a spare transport capacity of at least 1/M percent of their respective transport capacities.

22. A network as defined in claim 21, wherein M is at least two.

23. A network as defined in claim 20, wherein N is at least three.

24. A method for redirecting traffic in a mesh network comprising a plurality of computing nodes, the plurality of computing node being interconnected to one another by a plurality of communication links, the computing nodes being operative for exchanging traffic with one another over the communication links, said method comprising:
i) detecting a failure on a certain communication link part of the plurality of communication links, the certain communication link interconnecting a first computing node and a second computing node;
ii) upon detecting a failure on the certain communication link:
(1) generating a ring protection path between the first computing node and the second computing node, the ring protection path excluding the certain communication link;
(2) redirecting a least part of the traffic from the certain communication link to the ring protection path.

25. A method as defined in claim 24, wherein the ring protection path includes a group of communication links, the communication links having respective spare transport capacities prior to the redirecting of a least part of the traffic.

26. A method as defined in claim 25, wherein the ring protection path is capable of carrying a quantity of redirected traffic dependent on a spare transport capacity associated to a given communication link in the group of communication links.

27. A method as defined in claim 26, wherein the given communication link has the lowest spare transport capacity in the group of communication links.

28. A method as defined in claim 24, wherein the ring protection path is a bi-directional line switching ring (BLSR).

29. A method as defined in claim 24, wherein said ring protection path is a first ring protection path, said method further comprising:
i) generating a set of N ring protection paths between the first computing node and the second computing node, each ring protection path in the set of N ring protection paths excluding the certain communication link;
ii) redirecting at least part of the traffic from the certain communication link through the ring protection paths in the set of N ring protection paths.

30. A method as defined in claim 29, wherein each ring protection path in the set of N ring protection paths includes a group of communication links, the communication links having respective spare transport capacities prior to the redirecting of a least part of the traffic from the certain communication link through the ring protection paths in the set of N ring protection paths.

31. A method as defined in claim 24, wherein the ring protection path from the first computing node to a second computing node includes a third computing node distinct from the second computing node.

32. A method as defined in claim 31, wherein generating of the ring protection path comprises transmitting a message from either one of the first computing node and the second computing node to a third computing node in the network, the message being indicative of a request for generating a ring protection path between the first computing node and the second computing node.

33. A method as defined in claim 24, wherein the first computing node in the network is interconnected with M other computing nodes in the network over M communication links.

34. A method as defined in claim 33, wherein the M communication links have substantially similar respective transport capacities, in operation the communication links having a spare transport capacity of at least 1/M percent of their respective transport capacities.

35. A method as defined in claim 34, wherein M is at least two.

36. A method as defined in claim 33, wherein M is at least three.

37. A computer readable medium comprising a program element suitable for execution by a given computing apparatus for implementing traffic redirection in a network, the network having a plurality of computing apparatuses, said given computing apparatus comprising:
a) a port through which traffic can be exchanged between the computing apparatus and a remote computing apparatus over a certain communication link;
b) a processor operatively, said program element when executing on said processor being responsive to the occurrence of a failure on the certain communication link for:
i) causing the generation of a certain ring protection path between the computing apparatus and the remote computing apparatus on the basis of a set of alternate paths between the computing apparatus and the remote computing apparatus, the set of alternate paths including at least one path excluding the certain communication link;
ii) redirecting a least part of the traffic from the certain communication link to the certain ring protection path.

38. A computer readable medium as defined in claim 37, wherein the ring protection path includes a group of communication links, the communication links having respective spare transport capacities prior to the redirecting of a least part of the traffic.

39. A computer readable medium as defined in claim 38, wherein the ring protection path is capable of carrying a quantity of redirected traffic dependent on a spare transport capacity associated to a given communication link in the group of communication links.

40. A computer readable medium as defined in claim 39, wherein the given communication link has the lowest spare transport capacity in the group of communication links.

41. A computer readable medium as defined in claim 37, wherein the ring protection path operates as a bi-directional line switching ring (BLSR).

42. A computer readable medium as defined in claim 37, wherein said processor being responsive to the occurrence of a failure on the certain communication link for:
i) causing the generation a set of N ring protection paths on the basis of the set of ring protection paths between the computing apparatus and the remote computing apparatus, each ring protection path in the set of N ring protection paths excluding the certain communication link;
ii) redirecting at least part of the traffic from the certain communication link through the ring protection paths in the set of N ring protection paths.

43. A computer readable medium as defined in claim 42, wherein each ring protection path in the set of N ring protection paths includes a group of communication links, the communication links having respective spare transport capacities prior to the redirecting of a least part of the traffic from the certain communication link through the ring protection paths in the set of N ring protection paths.

44. A computer readable medium as defined in claim 37, wherein the remote computing apparatus is a first remote computing apparatus, the ring protection path from the computing apparatus to the first remote computing apparatus including a second remote computing apparatus distinct from the first remote computing apparatus.

45. A computer readable medium as defined in claim 44, wherein causing the generation of the ring protection path comprises transmitting a message to the second remote computing apparatus, the message being indicative of a request for generating a ring protection path excluding the certain communication link between the computing apparatus and the first remote computing apparatus.

46. A computing node suitable for use in a network having a plurality of computing nodes, said computing node comprising:
a) means through which traffic can be exchanged between the computing node and a remote computing node over a certain communication link;
b) processing means responsive to the occurrence of a failure on the certain communication link for:
(1) causing the generation of a certain ring protection path between the computing node and the remote computing node on the basis of a set of alternate paths between the computing node and the remote computing node, the set of alternate paths including at least one path excluding the certain communication link;
(2) redirecting a least part of the traffic from the certain communication link to the certain ring protection path.
